(19) United States
(12) Patent Application Publication
(10) Pub. No.: US 2012/0123652 A1
(43) Pub. Date: May 17, 2012

(54) DRIVE SYSTEM HAVING GEAR AND GROUNDSPEED RECALL

(76) Inventors: Brian D. ROCKWOOD, Washington, IL (US); Pierre Barriol, Sassenage (FR); Guillaume Raffin, Grenoble (FR); Chintan G. Kothari, Peoria, IL (US); Thomas L. Twigger, Peterborough (GB)

(21) Appl. No.: 12/945,581

(22) Filed: Nov. 12, 2010

(51) Int. Cl. B60W 10/10; B60W 10/06; B60W 30/18

(52) U.S. Cl. 701/54

(57) ABSTRACT

A drive system for a mobile machine is disclosed. The drive system may have an engine, a mechanical step-change transmission operatively connected to and driven by the engine, and a controller in communication with the engine and the mechanical step-change transmission. The controller may be configured to receive a first operator input to store as a target a current groundspeed of the mobile machine and a current gear selection of the mechanical step-change transmission, and receive a second operator input to recall the target when at least one of the groundspeed of the mobile machine and the gear selection of the mechanical step-change transmission is different from the target. The controller may further be configured to adjust a speed of the engine and a gear selection of the mechanical step-change transmission to achieve the recalled target.

### TECHNICAL FIELD

The present disclosure relates generally to a drive system, and more particularly, to a machine drive system having gear and groundspeed recall.

### BACKGROUND

Excavation machines such as dozers, wheel loaders, haul trucks, and other heavy equipment operate according to well known cycles to excavate, carry, load, and/or transport material. For example, a typical dozer cycle includes a dig segment, a push segment, and a return segment. During each of these segments, the dozer is controlled and performs differently. Specifically, during the dig segment, high forces and high precision are required to push a tool of the dozer into the material at an optimum attack angle and entry point. Accordingly, groundspeed is reduced during the dig segment, while a dozer blade is carefully lowered into position in preparation for the push segment. During the push segment, groundspeed and engine torque are increased as the blade is loaded and the dozer begins pushing the load along the ground surface as quickly as possible. During the return segment, the tractor is unloaded and reverses travel at high velocity back to the excavation point of entry to start the cycle over again. Each segment of the excavation cycle may require a different groundspeed, a different transmission gear ratio, a different engine speed, a different engine torque, and a different blade position for maximum efficiency and productivity. Accordingly, during machine operation, an operator is constantly changing machine settings to match requirements of each segment of the cycle.

Although effective, the constant machine adjustments can cause operator fatigue and increase the chance for operator error. In particular, the changes required during a single shift can number into the thousands, which can be very tiring for an operator to implement. In addition, the likelihood of the operator making poor speed or gear selections during at least some segments of the cycle, particularly toward the latter half of a shift when the operator is fatigued, may be high. Incorrectly setting an engine speed or a transmission gear ratio for even a single segment of a single cycle can reduce the machine's efficiency and productivity.

One attempt to improve machine efficiency is disclosed in U.S. Patent Publication No. 2009/0201250 of Vazquez et al. published on Aug. 13, 2009 (“the '250 publication”). Specifically, the '250 publication discloses a joystick assembly that provides enhanced operator control during rough operation such as dozing. The joystick assembly includes an upper housing generally perpendicular to a vertical axis of rotation, a palm support positioned on a distal end of the upper housing near a grip area, and three input devices located within the palm support. The input devices include a push button that permits an operator to selectively instruct a machine to resume a previous groundspeed, a thumb roller that controls the machine's groundspeed, and a switch that controls a transmission gear selection between forward, neutral, and reverse. By utilizing these input devices, an operator may recall a previously-stored machine groundspeed and make on-the-fly adjustments to that speed, if necessary, thereby reducing the number of machine setting changes and operator effort required during the excavation cycles described above.

Although the joystick assembly of the '250 publication may simplify control of an excavation machine by allowing recall of a previously-stored groundspeed, it may be less than optimal. In particular, the joystick assembly may do little to reduce the number of manual gear changes required during each segment of the excavation cycle when the machine is equipped with a mechanical step-change transmission.

The disclosed drive system is directed to overcoming one or more of the problems set forth above and/or other problems of the prior art.

### SUMMARY

In one aspect, the present disclosure is directed to a drive system for a mobile machine. The drive system may include an engine, a mechanical step-change transmission operatively connected to and driven by the engine, and a controller in communication with the engine and the mechanical step-change transmission. The controller may be configured to receive a first operator input to store as a target a current groundspeed of the mobile machine and a current gear selection of the mechanical step-change transmission, and receive a second operator input to recall the target when at least one of the groundspeed of the mobile machine and the gear selection of the mechanical step-change transmission is different from the target. The controller may further be configured to adjust a speed of the engine and a gear selection of the mechanical step-change transmission to achieve the recalled target.

In yet another aspect, the present disclosure is directed to another drive system for a mobile machine. This drive system may include an operator input device having an arm; a thumb roller disposed within a distal end of the arm, having a range of motion, and being configured to generate a first signal proportional to a position of the thumb roller within the range of motion; and a button disposed proximate the thumb roller and configured to generate a second signal when pushed. The drive system may also include a controller in communication with the operator input device. The controller may be configured to determine a desired change in a groundspeed of the mobile machine based on the first signal when the thumb roller is moved within a majority portion of its range, and to detect a desired change in transmission gear selection based on the first signal when the thumb roller is moved to end positions within its range. The controller may further be configured to detect a desire to store and recall a current groundspeed and a current transmission gear ratio based on the second signal.

In another aspect, the present disclosure is directed to another drive system for a mobile machine. This drive system may include an engine, a mechanical step-change transmission operatively connected to the engine, and a traction device driven by the mechanical step-change transmission. The drive system may also include an operator input device having a button configured to generate a first signal, a thumb roller configured to generate a second signal, and a switch configured to generate a third signal, and a controller in communication with the engine, the mechanical step-change transmission, and the operator input device. The controller may be configured to store as a target a current groundspeed of the traction device and a current gear selection of the mechanical step-change transmission based on the first signal. The controller may further be configured to recall a first target for use in controlling the engine and the mechanical step-change transmission based on the first signal, and recall a second target for use in controlling the engine and the mechanical step-change transmission based on the third signal.

### BRIEF DESCRIPTION OF THE DRAWINGS

FIG. 1 is a pictorial illustration of an exemplary disclosed machine;

FIG. 2 is a pictorial illustration of an exemplary disclosed operator interface device that may be used with the machine of FIG. 1;

FIG. 3 is a diagrammatic illustration of an exemplary disclosed drive system that may be used with the machine of FIG. 1; and

FIG. 4 is a flowchart depicting an exemplary disclosed method performed by the drive system of FIG. 3.

### DETAILED DESCRIPTION

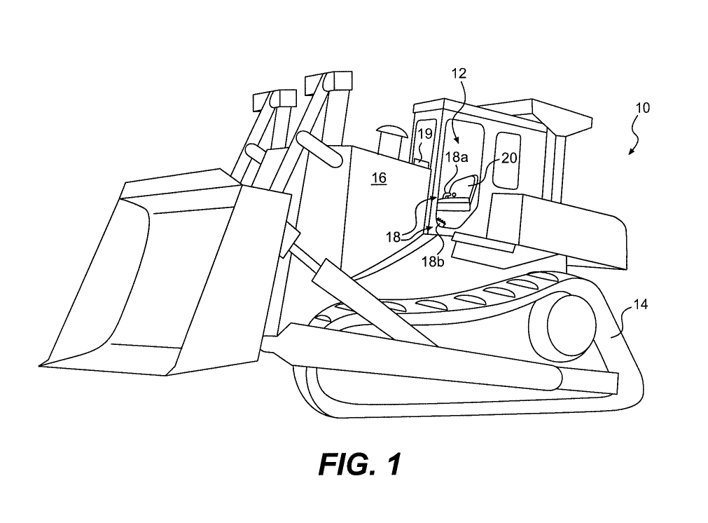

FIG. 1 illustrates an exemplary machine 10 having multiple systems and components that cooperate to accomplish a task. The tasks performed by machine 10 may be associated with a particular industry such as mining, construction, farming, transportation, or any other industry known in the art. For example, machine 10 may embody a mobile machine such as the dozer depicted in FIG. 1, a wheel-loader, an on- or off-highway haul truck, or another type of mobile machine known in the art. Machine 10 may include an operator station 12, one or more traction devices 14, and a powertrain 16 operatively connected to drive traction devices 14 in response to operator input received via operator station 12.

Operator station 12 may include devices that receive input from a machine operator indicative of desired machine maneuvering. Specifically, operator station 12 may include one or more operator interface devices 18 and a display 19 located proximate an operator seat 20. Operator interface devices 18 may initiate movement of machine 10 by producing displacement signals that are indicative of desired machine maneuvering. In one embodiment, operator interface devices 18 may include a joystick 18a and a deceleration pedal 18b. As an operator moves joystick 18a or manipulates deceleration pedal 18b, the operator may expect and affect a corresponding machine movement. It is contemplated that an operator interface device other than a joystick and a pedal such as, for example, a lever, a wheel, and other devices known in the art, may additionally or alternatively be provided within operator station 12 for movement control of machine 10, if desired.

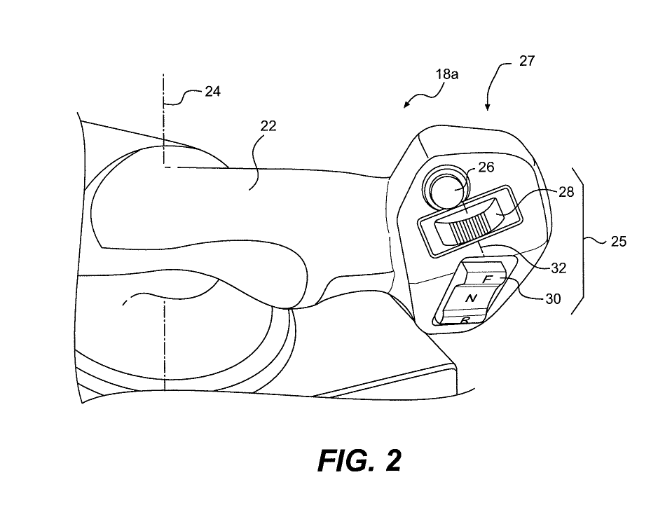

As shown in FIG. 2, joystick 18a may include a generally horizontal handle portion 22 that is pivotal in an azimuthal plane about a vertical axis 24. When handle portion 22 is pivoted horizontally about vertical axis 24 away from or toward an operator, a proportional signal may be generated indicative of a desired steering of machine 10. A plurality of activation components 25 may be located at a distal gripping end 27 of handle portion 22 and include a button 26, a thumb roller 28, and a rocker switch 30.

Button 26, as will be described in more detail below, is a spring-released momentary button that may be selectively depressed by an operator to generate a signal indicative of a desire to store or recall a previously-stored travel target that includes both a ground speed component and a transmission gear selection component. By depressing and holding down button 26 for a period of time, for example about three seconds, current travel conditions may be stored as a target. By quickly depressing and releasing button 26, the stored travel target may be subsequently recalled and used to control machine 10.

Thumb roller 28 may be spring-centered and rotatable about an axis 32 through an angle of about ±20° (i.e., through a total range of about 40°) to generate signals associated with a groundspeed and a desired gear selection. For example, when rotated in a counterclockwise direction from a centered position (i.e., from a 0° position) to about −18°, a proportional signal indicative of the operator's desire to slow machine 10 may be generated. Similarly, when rotated in a clockwise direction from the centered position to about +18°, a proportional signal indicative of the operator's desire to speed up machine 10 may be generated. When rotated from the centered position to extreme positive and negative positions (i.e., to end positions past ±18°, a signal indicative of the operator's desire to shift down (−18° to −20° or shift up (+18° to +20°) a transmission gear selection may be generated. Accordingly, when rotated within a majority portion of its total range, thumb roller 28 may generate ground speed signals (e.g., an engine speed signal and gear selection signal) and, when rotated to end positions within its total range, thumb roller 28 may generate transmission selection signals (e.g., only a gear selection signal). For example, when rotated to 5°, thumb roller 28 may generate a signal indicative of a desire to increase ground speed by 3 mph (or to increase engine speed by 200 rpm while remaining in second gear), but when rotated to 19°, thumb roller 28 may generate a signal requesting the transmission gear selection be changed to third gear.

Switch 30 may be a rocker-type switch movable between three distinct positions. When rocked to an upper position marked “F”, a signal indicative of desired machine travel in a forward direction may be generated. When rocked to a lower position marked “R”, a signal indicative of desired machine travel in a reverse direction may be generated. When rocked to a center position marked “N” that is located between the upper and lower positions, a signal indicative of a desired neutral transmission selection may be generated.

Deceleration pedal 18b (referring to FIG. 1) may be movable through a range from a neutral released position to a maximum displaced position to generate a proportional signal indicative of an operator's desire to reduce an engine speed of machine 10. In some applications, deceleration pedal 18b may also be coupled to a brake (not shown) such that the brake is actuated toward an end of travel of deceleration pedal 18b away from its neutral position.

Display 19 (referring to FIG. 1) may be any appropriate type of device that provides a graphics user interface (GUI) for presentation of machine performance and/or information to operators and other users of machine 10. For example, display 19 may be a computer console or a cab-mounted monitor. In one example, display 19 may be configured to present a current groundspeed, a current travel direction, a current transmission gear selection, a current engine speed, a current transmission mode, and an activation status of a user-modified travel mode of operation. It is contemplated that display 19 may also be configured to receive input from an operator regarding desired modes of operation, for example by way of a touch screen interface, if desired.

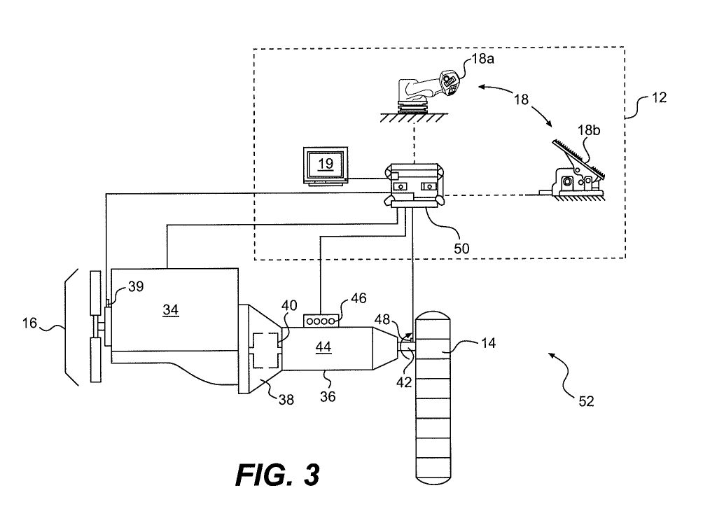

As illustrated in FIG. 3, powertrain 16 may be an integral package configured to generate and transmit power to traction devices 14 to propel machine 10. In particular, powertrain 16 may include a power source 34 operable to generate a mechanical power output, a transmission 36 connected to receive the mechanical power output and transmit the mechanical power output in a useful manner to traction devices 14, and a torque converter 38 located between power source 34 and transmission 36. It is contemplated that additional components may be included within powertrain 16, if desired.

Power source 34 may include an internal combustion engine having multiple subsystems that cooperate to produce mechanical or electrical power output. For the purposes of this disclosure, power source 34 is depicted and described as a four-stroke diesel engine. One skilled in the art will recognize, however, that power source 34 may be any other type of internal combustion engine such as, for example, a gasoline or a gaseous fuel-powered engine. The subsystems included within power source 34 may include, for example, a fuel system, an air induction system, an exhaust system, a lubrication system, a cooling system, and/or any other appropriate system.

A sensor 39 may be associated with power source 34 to sense an output speed thereof. In one example, sensor 39 may embody a magnetic pickup type of sensor associated with a magnet embedded within a rotational component of power source 34 such as a crankshaft or a flywheel. During operation of power source 34, sensor 39 may sense the rotating field produced by the magnet and generate a signal corresponding to the rotational speed of power source 34.

Transmission 36 may embody a mechanical step-change transmission. In particular, transmission 36 may be a multi-speed, bidirectional, mechanical transmission having an input 40, an output 42, a plurality of intermeshing gear combinations 44 disposed between input 40 and output 42, and a shift system 46 that controls which combination of gears are intermeshed at a given time to produce a desired speed ratio between input 40 and output 42. The intermeshing gear combinations may be arranged in a parallel shaft configuration, a planetary configuration, or a hybrid configuration, as desired. It is contemplated that any number of gear combinations in a forward and a reverse travel direction may be included within transmission 36. The structure of the gears, input members, output members, coupling members, and the connections therebetween can be achieved using components known in the art.

A sensor 48 may be associated with transmission 36 to sense an output speed thereof. In one example, sensor 48 may embody a magnetic pickup type of sensor associated with a magnet embedded within a rotational component of transmission 36 such as output 42. During operation of transmission 36, sensor 48 may sense the rotating field produced by the magnet and generate a signal corresponding to the groundspeed of machine 10. Alternatively, the ground speed signal may be produced by another type of sensor, if desired, such as a gps sensor, a radar sensors, a lidar sensor, a laser sensor, or other sensor known in the art.

Torque converter 38 may include, for example, a pair of opposing hydraulic impellers driven by pressurized oil to selectively couple, partially couple, and/or decouple power source 34 with transmission 36. Torque converter 38 may allow power source 34 to rotate somewhat independently of transmission 36. The amount of independent rotation between power source 34 and transmission 36 may be varied by modifying a pressure of the oil supplied to torque converter 38. It is contemplated that a mechanical torque converter may alternatively be utilized if desired.

Operator station 12 and powertrain 16, together with a controller 50, may form a drive system 52. Controller 50 may receive operator input from operator station 12 and, based on the input, affect operational changes of powertrain 16, including engine speed, groundspeed, and transmission gear selection changes, as will be described in the following section.

Controller 50 may embody a single or multiple microprocessors, field programmable gate arrays (FPGAs), digital signal processors (DSPs), etc., that include a means for controlling an operation of drive system 52 in response to the signals received from operator interface devices 18 and from sensors 39 and 48. Numerous commercially available microprocessors can be configured to perform the functions of controller 50. It should be appreciated that controller 50 could readily embody a microprocessor separate from that controlling other machine-related functions, or that controller 50 could be integral with an machine microprocessor and be capable of controlling numerous machine functions and modes of operation. If separate from the general machine microprocessor, controller 50 may communicate with the general machine microprocessor via datalinks or other methods. Various other known circuits may be associated with controller 50, including power supply circuitry, signal-conditioning circuitry, actuator driver circuitry (i.e., circuitry powering solenoids, motors, or piezo actuators), and communication circuitry.

One or more machine (i.e., engine and/or transmission) control maps relating operator input, current groundspeed, current engine speed, current transmission gear selection, desired groundspeed, desired engine speed, desired transmission gear selection, engine speed limits, groundspeed limits, etc., may be stored within the memory of controller 50. Each of these maps may be in the form of tables, graphs, and/or equations and include a compilation of data collected from lab and/or field operation of drive system 52. Controller 50 may reference these maps and control the operation of power source 34 and/or transmission 36 to bring the operation of drive system 52 in line with operator expected or desired performance of machine 10.

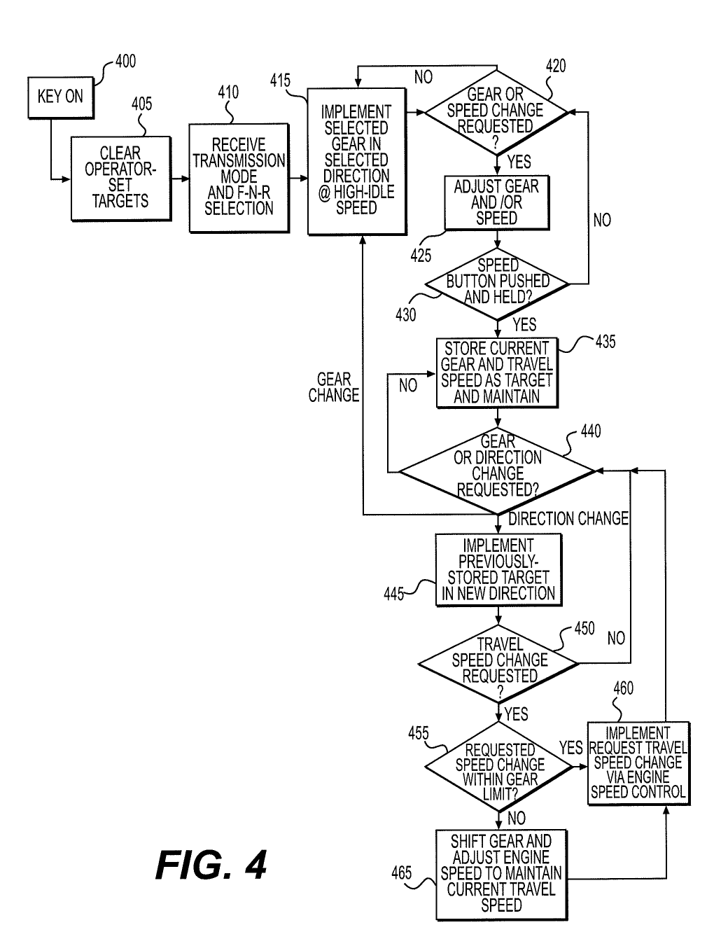

FIG. 4 is a flow chart depicting an exemplary method performed by controller 50 during operation of drive system 52. FIG. 4 will be discussed further in the following section to better illustrate the disclosed system and its operation.

### INDUSTRIAL APPLICABILITY

The disclosed drive system may be utilized to simplify operator actions during repetitive excavation cycles. The disclosed drive system may simplify operator actions by providing for storage and recall of groundspeed and transmission gear selections commonly used by the operator, thereby reducing the number of manual operational changes required to complete the cycle. Operation of drive system 52 will now be described.

Operation of drive system 52 may begin when an operator of machine 10 turns a key to power-up machine 10 (Step 400). Once machine 10 has been powered-up, controller 50 may clear its internal memory of any stored travel target values that were previously set by the operator (Step 405). These target values may include, among other things, the groundspeed component and the transmission gear selection component discussed above. Controller 50 may then receive from the operator a desired transmission mode (410).

The transmission mode may be selected by the operator via display 19 or in another manner, and include a selection of four possible modes. In the first transmission mode, controller 50 may communicate with shift system 46 to select a first or lowest gear for use by transmission 36 during initial operations in both forward and reverse directions. In the second transmission mode, controller 50 may communicate with shift system 46 to select a second or next lowest gear for use by transmission 36 during initial operation in the forward direction, and the first gear for use during initial operation in the reverse direction. In the third transmission mode, controller 50 may communicate with shift system 46 to select the second gear for use by transmission 36 during initial operation in the reverse direction, and the first gear for use during initial operation in the forward direction. In the fourth transmission mode, controller 50 may communicate with shift system 46 to select any of the available gears for use by transmission 36 during initial operations in the forward and reverse directions, the gears being the same or different for each direction, as desired by the operator. For example, the operator may select fourth gear for use in the forward direction and first gear for use in the reverse direction, when operating in the fourth transmission mode. The gear selections in the fourth transmission mode may be customizable by the operator at the start of machine operation.

After the desired transmission mode has been chosen, the operator may release a parking brake (not shown), and rock switch 30 from the neutral position to either of the reverse or forward positions to indicate a desired travel direction of machine 10. Upon receiving the corresponding signal from switch 30 (Step 410), controller 50 may communicate with shift system 46 to select the transmission gear that is associated with the desired travel direction and the transmission mode chosen by the operator, and adjust the engine speed of power source 34 to a predetermined speed setting (e.g., high-idle) associated with the gear selection (Step 415). At this point in time, machine 10 may begin to travel in the desired direction at a groundspeed corresponding to the predetermined engine speed of power source 34 and the current gear selection of transmission 36.

At any point in time during the travel of machine 10, the operator may choose to change the groundspeed of machine 10 and/or the gear selection of transmission 36 away from the initial transmission mode settings. The groundspeed may be changed, for example, via deceleration pedal 18b. Specifically, as the operator pushes deceleration pedal 18b away from its neutral released position and towards its maximum displaced position, controller 50 may receive the proportional signal generated by deceleration pedal 18b and responsively adjust operation of power source 34 to reduce the engine speed thereof (i.e., to reduce power source output speed and transmission input speed). The reduced engine speed, coupled with the same transmission gear selection, may result in a lower groundspeed of machine 10. Alternatively or additionally, the groundspeed of machine 10 may be reduced by rotating thumb roller 28 away from neutral in the negative direction (i.e., by rotating thumb roller 28 in the counterclockwise direction, when viewed from above). This rotation of thumb roller 28 may generate a corresponding signal that causes controller 50 to reduce the engine speed of power source 34. Controller 50 may reduce the engine speed of power source 34 by controlling the fuel system, the air inductions system, the exhaust system, and/or another system of power source 34 to reduce an amount of fueling and/or an amount of available combustion air thereof.

The gear selection of transmission 36 may be adjusted by movement of thumb roller 28 to its end positions. For example, by rotating thumb roller 28 counterclockwise past about −18° from the neutral position, thumb roller 28 may be caused to generate a signal indicative of a desire to reduce the gear selection of transmission 36. Similarly, by rotating thumb roller 28 counterclockwise past about +18° from the neutral position, thumb roller 28 may be caused to generate a signal indicative of a desire to increase the gear selection of transmission 36. Upon receipt of these signals from thumb roller 28, controller 50 may communicate with shift system 46 to implement the desired gear selection.

Controller 50 may continuously monitor the signals from deceleration pedal 18b and from thumb roller 28 to determine if a desired gear selection or groundspeed change has been requested (Step 420). If no changes to the selected transmission gear selection or groundspeed are requested (Step 420: No), control may return to step 415 and machine 10 may continue its operation substantially unaffected. If, however, at step 420, a transmission gear selection or groundspeed change is requested, controller 50 may temporarily implement those changes. The changes to the transmission gear selection or groundspeed may be implemented until a travel direction reversal of machine 10 occurs.

Once the direction of machine 10 shifts from forward to reverse or from reverse to forward, the temporary gear selection may change according to the chosen transmission mode, and the engine speed of power source 34 may return to the predetermined (e.g., high-idle) speed corresponding to the transmission gear selection. For example, if the first transmission mode had been initially chosen by the operator, travel has been in the forward direction in the second transmission gear and at the predetermined engine speed, and the operator had temporarily decreased engine speed or increased the transmission gear, after switching from forward to reverse and then returning back to forward again, transmission 36 would be shifted to second gear corresponding to the selected transmission mode and power source 34 would return to the predetermined (high-idle) engine speed. In other words, by changing travel directions, the temporary gear selection and/or engine speed change may be cleared from memory and operation would be defined by the originally-selected transmission mode.

If the operator wishes to save the modified gear selection or engine speed setting for subsequent use when returning to the same travel direction, the operator may store the modifications in the memory of controller 50. In particular, after making modifications to the gear selection and/or to the groundspeed that results in an engine speed change, the operator may depress button 26 and hold button 26 in the depressed position for about 3 seconds. Controller 50 may monitor the signals produced by button 26 at this time (Step 430), and determine if the required period of time has elapsed. If button 26 has been held in the depressed position for the required period of time, the current transmission gear selection and groundspeed settings may be stored in the memory of controller 50 as a travel target for later use in the current direction (Step 435). If deceleration pedal 18b had been used to reduce the engine speed of power source 34 to the target level, deceleration pedal 18b may be released after controller 50 stores the associated settings and machine 10 may be controlled to continue at its current groundspeed in the current transmission gear selection without interruption. Machine 10 may now be operating in a user-modified target mode of operation, and display 19 may illuminate a corresponding lamp or other indicator suggesting that such a mode has been triggered by the operator. It is contemplated that multiple recall buttons 26 may be utilized to store and recall different desired travel speed/gear selection targets, if desired.

After storing the travel target in memory, controller 50 may monitor operator input to determine if a change in transmission gear selection or travel direction is requested (Step 440). If at this time, a transmission gear selection change is requested (Step 440: Gear Change), controller 50 may cancel use of the stored travel target (controller 50 may exit the user-modified target mode of operation) and return to step 415, where controller 50 may implement the requested gear change and increase engine speed to high-idle. Controller 50 may also cause display 19 to provide an indication that the user-modified target mode of operation is no longer in use (i.e., display 19 may be caused to stop illuminating the lamp discussed above).

If, at step 440, while still operating in the user-modified target mode of operation, a direction change is requested (Step 440: Direction Change), controller 50 may recall from memory a previously stored transmission gear selection and a previously stored groundspeed corresponding with the newly requested travel direction, and implement the recalled travel target (Step 445). For example, if while operating in the user-modified mode in the forward direction, the operator requests a travel direction change to reverse, controller 50 may cancel the forward travel target currently being used and recall from memory a previously defined and stored second travel target associated with the reverse direction. Similarly, when returning from the reverse direction to the forward direction, controller 50 may resume machine travel at the user-modified forward groundspeed and in the user-modified forward transmission gear selection. In other words, a direction change may not cause the controller 50 to exit the user-modified target mode of operation, but instead only cause controller 50 to recall a different travel target associated with the new travel direction. Alternatively, it is contemplated that a change in travel direction, similar to change in transmission gear selection, may cause controller 50 to cancel the use of the stored travel targets (i.e., to exit the user-modified target mode of operation), if desired.

Similar to what was described above, the operator may make temporary adjustments to the groundspeed of machine 10 while operating in the user-modified target mode of operation. That is, while controller 50 is regulating machine operation according to a previously-stored travel target associated with the current travel direction, the operator may request groundspeed changes via thumb roller 28. Controller 50 may monitor the signals from thumb roller 28 to determine if any groundspeed changes have been requested (Step 450), and then compare the requested groundspeed changes with a lookup map stored in memory. Controller 50 may determine if the groundspeed changes being requested are within limits associated with the current transmission gear selection (Step 455), and respond accordingly. That is, each gear selection of transmission 36 may have corresponding engine and groundspeed ranges, from allowed minimum speeds to maximum allowed speeds. Controller 50 may implement the requested groundspeed change in its entirety only if the requested groundspeed change results in the actual ground and engine speeds of machine 10 remaining within the corresponding ranges (Step 450). Otherwise, controller 50 may be configured to implement the requested groundspeed changes only until the actual groundspeed and/or engine speed reaches a limit of the corresponding speed ranges, before implementing a physical transmission gear shift and subsequently continuing the groundspeed increase in the new corresponding speed ranges (Step 465).

As described above, groundspeed changes may be implemented by regulating an engine speed of power source 34. And, in order to provide a continuous smooth groundspeed increase of machine 10 according to the operator's request, controller 50 may be configured to reverse the engine speed change of power source 34 at the time of transmission gear shifting. For example, if operating power source 34 at 1800 rpm in second gear, and a groundspeed increase of 2.0 kph is requested, controller 50 may increase engine speed to about 1875 rpm, then cause transmission 36 to shift to third gear while reducing engine speed to about 1350 rpm, and then continue increasing engine speed to about 1775 rpm, resulting in the groundspeed increase of 2.0 kph. Although, in this example, engine speed may change in a general step-wise manner, the resulting groundspeed change of machine 10 may be substantially smooth and continuous throughout the gear shift. If the engine speed of power source 34 was not reduced during transmission shifting from second to third gear, machine 10 could instead experience a sudden step increase in machine groundspeed that would be uncomfortable for the operator and/or cause damage to machine 10. It is contemplated that, during groundspeed changes such as the one described above, controller 50 may be configured to pause a period of time just before causing transmission 36 to physically shift gear selections to alert the operator of the ensuing shift and confirm the operator's intentions, if desired. During this pause, the operator may have the chance to cancel or truncate the requested change.

In some embodiments, each transmission gear selection may be divided into multiple virtual gear selections. Specifically, each transmission gear selection may be divided into at least two virtual gear selections each having their own corresponding engine and groundspeed ranges. For example, the first physical gear selection of transmission 36 may be divided into two selections, including a 1.0 gear selection and a 1.5 gear selection. When performing a shift between two virtual gear selections, controller 50 may simply switch between sets of engine and groundspeed ranges for use in controlling machine 10, and illuminate corresponding lamps in display 19 informing the operator of the switch. Because the virtual gear shifts may not correspond with physical gear selection changes within transmission 36, controller 50 may not adjust engine speed in a step-wise manner during virtual shifting as is described above with regard to actual physical gear shifting of transmission 36. However, even during virtual shifting before controller 50 changes engine and/or groundspeeds according to different pre-defined ranges, controller 50 may still be configured to pause a period of time to alert the operator of the ensuing shift and confirm the operator's intentions, if desired.

In some situations, power source 34 may become overloaded and unable to increase the engine speed of power source 34 sufficiently to achieve the operator's requested groundspeed. In these situations, the operator's groundspeed request may be limited such that, when power source 34 recovers and has increased capacity, machine 10 does not experience a sudden surge in groundspeed.

By allowing both a groundspeed and a transmission gear selection to be stored and later recalled, operation of machine 10 may be enhanced. For example, when initiating operation of a dozer in a slot-dozing application (i.e., a dozing application involving only back and forth motion that removes material in ever-deepening layers), the operator may choose the first transmission mode of operation. In this mode, the operator may be able to push material forward in the second gear with power source 34 at high-idle, and then backtrack to the point of excavation entry also in the second gear and at high-idle. During the digging segment of this cycle, however, the operator may desire to operate in first gear and at a slower groundspeed. Normally, the operator would have to manually shift gears and then use deceleration pedal 18b during this segment of the excavation cycle to slow the engine speed of power source 34, and then manually shift gears again and release deceleration pedal 18b when the segment was complete. By using the disclosed drive system, however, the operator may now only need to store the initial modified gear selection and groundspeed setting as a target using button 26, and thereafter just press button 26 briefly to recall and use the stored target each time the digging segment begins. The operator, after the initial setup segment, may no longer need to manually shift gears and manually change machine groundspeeds at any point in time during the excavation cycle. This ability may improve machine efficiency and productivity.

It will be apparent to those skilled in the art that various modifications and variations can be made to the disclosed drive system without departing from the scope of the disclosure. Other embodiments of the disclosed drive system will be apparent to those skilled in the art from consideration of the specification and practice of the drive system disclosed herein. For example, although the save/recall functionality is described herein in conjunction with both forward and reverse directions, it is contemplated that this functionality may only be available in only one of the forward and reverse directions, if desired. In this situation, when operating for example in the reverse direction and button 26 is depressed to recall a forward travel speed and transmission gear selection, nothing may happen until the travel direction of machine 10 first switches to forward, at which time the previously stored target may then be recalled and utilized. It is intended that the specification and examples be considered as exemplary only, with a true scope of the disclosure being indicated by the following claims and their equivalents.

What is claimed is:

1. A drive system for a mobile machine, comprising:
an engine;
a mechanical step-change transmission operatively connected to and driven by the engine; and
a controller in communication with the engine and the mechanical step-change transmission, the controller being configured to:
receive a first operator input to store as a target a current groundspeed of the mobile machine and a current gear selection of the mechanical step-change transmission;
receive a second operator input to recall the target when at least one of the groundspeed of the mobile machine and a gear selection of the mechanical step-change transmission is different from the target; and
adjust at least one of the speed of the engine and the gear selection of the mechanical step-change transmission to achieve the recalled target.

2. The drive system of claim 1, wherein:
the target includes a forward target and a reverse target; and
the controller is configured to automatically adjust operation of the engine and the mechanical step-change transmission to achieve the forward or reverse target after receipt of the second operator input when a travel direction of the mobile machine changes.

3. The drive system of claim 1, wherein a speed of the engine corresponding with the target is less than a high-idle speed.

4. The drive system of claim 1, wherein the controller is further configured to:
receive a third operator input indicative of a desire for the mobile machine to deviate from the target;
temporarily adjust at least one of a speed of the engine and the gear selection of the mechanical step-change transmission based on the third input; and
return the speed of the engine and the gear selection of the mechanical step-change transmission to the target when the second operator input is received.

5. The drive system of claim 4, wherein the controller is further configured to:
receive a fourth operator input requesting a change in the gear selection of the mechanical step-change transmission; and
increase a speed of the engine to high idle based on the fourth operator input.

6. The drive system of claim 5, wherein the first, second, third, and fourth inputs are received through a single operator input device.

7. The drive system of claim 6, wherein the controller is configured to store the target when it is determined that the operator input device is activated by the operator for at least a threshold period of time.

8. The drive system of claim 7, wherein the operator input device is movable through a range and the fourth operator input is detected when the operator input device is activated by the operator to an end position within the range.

9. The drive system of claim 5, wherein each gear selection of the mechanical step-change transmission is divided into multiple virtual gear ranges, each of the multiple virtual gear ranges having a corresponding engine speed range.

10. The drive system of claim 9, wherein the controller is configured to pause for a period of time when temporarily adjusting the speed of the engine based on the third input when the engine speed reaches a limit of the engine speed range.

11. The drive system of claim 5, wherein the controller is further configured to:
increase the speed of the engine to a maximum based on the third input indicative of a desire to increase groundspeed away from the target;
shift the mechanical step-change transmission to a higher gear selection based on the third input when the third input indicates a desire for increased groundspeed after the engine speed has reached the maximum; and
decrease the engine speed during shifting up such that the groundspeed of the mobile machine increases at a substantially continuous rate through the shift.

12. The drive system of claim 1, wherein the controller is further configured to:
receive a third operator input of a desired mode of multiple available transmission modes of operation; and
implement the desired mode of operation when the target has not been recalled.

13. The drive system of claim 12, wherein the multiple available transmission modes of operation include:
a first mode of operation wherein a forward travel gear selection of the mechanical step-change transmission is predetermined and the same as a reverse travel gear selection;
a second mode of operation wherein the forward travel gear selection of the mechanical step-change transmission is predetermined and different than the reverse travel gear selection; and
a third mode of operation wherein at least one of the forward and reverse travel gear selections is customizable by the operator.

14. A drive system for a mobile machine, comprising:
an operator input device having:
an arm;
a thumb roller disposed within a distal end of the arm, having a range of motion, and being configured to generate a first signal proportional to a position of the thumb roller within the range of motion; and
a button disposed proximate the thumb roller and configured to generate a second signal when pushed; and
a controller in communication with the operator input device, the controller configured to:
determine a desired change in a groundspeed of the mobile machine based on the first signal when the thumb roller is moved within a majority portion of its range;
detect a desired change in transmission gear selection based on the first signal when the thumb roller is moved to end positions within its range; and
detect a desire to store and recall a current groundspeed and a current transmission gear selection based on the second signal.

15. The drive system of claim 14, wherein the controller detects a desire to store the current groundspeed and the current transmission gear selection based on a duration of the second signal.

16. A drive system for a mobile machine, comprising:
an engine;
a mechanical step-change transmission operatively connected to the engine;
a traction device driven by the mechanical step-change transmission;
an operator input device having a button configured to generate a first signal, a thumb roller configured to generate a second signal, and a switch configured to generate a third signal; and
a controller in communication with the engine, the mechanical step-change transmission, and the operator input device, the controller being configured to:
store as a target a current groundspeed of the mobile machine and a current gear selection of the mechanical step-change transmission based on the first signal;
recall a first target for use in controlling the engine and the mechanical step-change transmission based on the first signal; and
recall a second target for use in controlling the engine and the mechanical step-change transmission based on the third signal.

17. The drive system of claim 16, wherein:
the third signal is indicative of an operator desired travel direction;
the first target corresponds to a forward travel direction; and
the second target corresponds to a reverse travel direction.

18. The drive system of claim 16, wherein the controller is further configured to:
temporarily adjust a speed of the engine and a gear selection of the mechanical step-change transmission away from the first target based on the second signal; and
return the speed of the engine and the gear selection of the mechanical step-change transmission to the first target based on the third signal.

19. The drive system of claim 18, wherein the controller is further configured to change a gear selection of the mechanical step-change transmission based on the second signal.

20. The drive system of claim 19, wherein:
the controller stores as a target the current groundspeed and the current gear selection only when the first signal indicates the button has been activated by the operator for at least a threshold period of time; and
the controller changes the gear selection of the mechanical step-change transmission based on the second signal only when the second signal indicates that the thumb roller has been moved by the operator to an extreme position.
